(19) United States
(12) Patent Application Publication
(10) Pub. No.: US 2017/0132614 A1
(43) Pub. Date: May 11, 2017

(54) Systems and Methods for Processing Payments

(71) Applicants: Ravi ACHARYA, Philadelphia, PA (US); Margaret Haggerty, New York, NY (US); Kashif M. Siddiqui, Livingston, NJ (US); Sablne Gayle, Princeton Junction, NJ (US)

(72) Inventors: Ravi ACHARYA, Philadelphia, PA (US); Margaret Haggerty, New York, NY (US); Kashif M. Siddiqui, Livingston, NJ (US); Sablne Gayle, Princeton Junction, NJ (US)

(73) Assignee: JPMorgan Chase Bank, N.A.

(21) Appl. No.: 13/206,967

(22) Filed: Aug. 10, 2011

Related U.S. Application Data
(60) Provisional application No. 61/478,807, filed on Apr. 25, 2011.

(51) Int. Cl. G06Q 40/00

(52) U.S. Cl. CPC G06Q 20/38

(57) ABSTRACT

The invention provides systems and methods for performing a funds transfer between a first customer and a second customer, the processing system tangibly embodied in the form a computer. The processing system may include a bank processing portion that performs processing in conjunction with the funds transfer; and a bank database which contains data used in the funds transfer processing. The bank processing portion may perform processing including: (1) inputting a funds transfer request from the first customer through interfacing with the first customer, the bank processing portion providing a plurality of options to the first customer, the options controlling first attributes of the funds transfer; (2) interfacing with the second customer including providing a plurality of options to the second customer, the options controlling second attributes of the funds transfer; (3) aggregating the first attributes and the second attributes; and (4) performing the funds transfer based on the aggregated attributes.

### RELATED PATENT APPLICATION

This application claims priority to U.S. Provisional Patent Application 61/478,807 filed Apr. 25, 2011, the content of which is incorporated herein by reference in its entirety.

### BACKGROUND OF THE INVENTION

The invention relates to transaction processing, and in particular funds transfers from one person to another person

In the financial industry, transaction processing to effect funds transfer between two persons is known. However, known techniques are lacking in providing needed tools and capabilities to customers. The systems and methods of the invention address shortcomings of known technology related to such practices, as well as set forth various other concepts.

### BRIEF SUMMARY OF THE INVENTION

The invention provides systems and methods for performing a funds transfer between a first customer and a second customer, the processing system tangibly embodied in the form a computer. The processing system may include a bank processing portion that performs processing in conjunction with the funds transfer; and a bank database which contains data used in the funds transfer processing. The bank processing portion may perform processing including: (1) inputting a funds transfer request from the first customer through interfacing with the first customer, the bank processing portion providing a plurality of options to the first customer, the options controlling first attributes of the funds transfer; (2) interfacing with the second customer including providing a plurality of options to the second customer, the options controlling second attributes of the funds transfer; (3) aggregating the first attributes and the second attributes; and (4) performing the funds transfer based on the aggregated attributes.

### BRIEF DESCRIPTION OF THE DRAWINGS

The present invention can be more fully understood by reading the following detailed description together with the accompanying drawings, in which like reference indicators are used to designate like elements, and in which:

FIG. 1 is a block diagram of a payment system 10 in accordance with one embodiment of the invention.

FIG. 2 is a high level flowchart showing features of the invention in accordance with one embodiment of the invention.

FIG. 3 is a flowchart showing further details of the “bank processing portion 210 interfaces with initiating customer to perform funds transfer” step 520 of FIG. 2, in accordance with one embodiment of the invention.

FIG. 4 is a flowchart showing in further detail the “bank processing portion 210 interfaces with the responding customer to perform funds transfer” step 530 of FIG. 2, in accordance with one embodiment of the invention.

FIG. 5 is a flowchart showing in further detail the “bank processing portion interfaces with the customer device to collect attributes for a funds transfer request” processing of FIG. 3 and FIG. 4, in accordance with one embodiment of the invention.

FIG. 6 is a flowchart showing in further detail the “bank processing portion 210 looks to the customer record to determine which rules are in place (if any) to control further attributes of the funds transfer” step 760 of FIG. 5, in accordance with one embodiment of the invention.

FIG. 7 is a flowchart showing in further detail the “bank processing portion 210 further interfaces with the customer device to collect any further needed attributes to perform the funds transfer” step 770 of FIG. 5, in accordance with one embodiment of the invention.

FIG. 8 is a flowchart showing in further detail the “bank processing portion 210 (through prompt to user or automatically based on entered attributes) invokes ‘option sets’ processing” step 780 of FIG. 6, in accordance with one embodiment of the invention.

FIG. 9 is a diagram showing aspects of participants in a funds transfer, in accordance with one embodiment of the invention.

FIG. 10 is an illustrative GUI (graphical user interface) in which the customer may control routing options for a funds transfer in accordance with one embodiment of the invention.

FIG. 11 is an illustrative GUI in which the customer may prompt the bank processing portion 210 to “send money” in accordance with one embodiment of the invention.

FIG. 12 is an illustrative GUI showing details of a customer entering payment details such as recipient name, nickname, amount, pay from account and/or send on date, for example, in accordance with one embodiment of the invention.

FIG. 13 is a GUI presented to the customer to verify details of the funds transfer in accordance with one embodiment of the invention.

FIG. 14 is a GUI showing confirmation of a funds transfer, in accordance with one embodiment of the invention.

FIG. 15 is a diagram showing the form and content of an illustrative e-mail, in accordance with one embodiment of the invention.

FIG. 16 is a GUI which might be generated in conjunction with step 532 (FIG. 4) to send funds to the customer's bank account, in accordance with one embodiment of the invention.

FIG. 17 is an illustrative GUI which might be generated in conjunction with step 532 (FIG. 4), to send funds to the customer's credit card, for example, in accordance with one embodiment of the invention.

### DETAILED DESCRIPTION OF THE INVENTION

Hereinafter, aspects of the payment processing system in accordance with various embodiments of the invention will be described. As used herein, any term in the singular may be interpreted to be in the plural, and alternatively, any term in the plural may be interpreted to be in the singular.

The terms “data” and “information” are used herein interchangeably.

The invention relates to processing to perform transfer of funds from one person to another person. Technology providing person to person transactions, also known as “P2P” transactions are known. Such transactions commonly involve a first person (the sender) interfacing with a service to send cash to a second person (the receiver). In interfacing with the service, the sender typically designates the particular account to withdraw the funds. The receiver might also interface with the service to designate a particular account to send the funds.

However, known technologies have shortcomings. The systems and methods of the invention provide a variety of features that enhance the P2P experience including providing a variety of novel capabilities above and beyond that currently provided. In particular, in the invention either the sender and/or the receiver (i.e., the “transaction participants”) may specify a wide variety of parameters of the transaction including accounts involved and the manner in which funds are transferred between the accounts, i.e., the routing of the transaction. For example, various rules may be used that control account/routing parameters the sender controls and account/routing parameters the receiver controls. Such processing may utilize various known payment processing including wire, ACH, credit, debit, PayPal and related processing, and cashiers check. For example, in the invention, the sender or the receiver might request that the bank platform (that provides the processing of the invention) withdraw the funds from a designated account and prepare a cashiers check—for forwarding to the receiver. In some embodiments, it is not necessary that the sender or the receiver be a customer of the particular bank. However, in other embodiments it is needed that all participates be registered, or in some other manner, associated with a particular bank involved in the transaction. Any suitable payment type may be utilized in conjunction with the features of the invention including those described above and others. For example, other payment types might include Facebook or other social network credits (in which the credits move on corresponding payment channels); intrabank transfer; image clearing (for example as such relates to paper check clearing) and prepaid related payment methods, for example.

In accordance with embodiments of the invention, various parameters of a transaction may dictate, i.e., control, other parameters. For example, if the customer requests a quick transfer of funds, such may dictate that only certain payment methods might be utilized. For example, if the timing of a transfer is very short, a wire transfer might be automatically presented to the customer as the only payment method option. The bank processing portion 210 may automatically impose various other required predetermined interrelationships between parameters of a transaction.

Various other related capabilities are provided by the systems and methods of the invention. For example, ATM cash pickup at an ATM may be provided with same day payment option, using a wires or cards platform. With the various features provided, fees may be charged to a transaction participant so as to create a win-win situation between the transaction participants and the bank. For example, if a sender delays in sending a payment to a receiver, the sender may still get the payment in on time by utilizing an expedited approach. A fee may be imposed for such processing so as to cover the additional expense and/or risk imposed on the bank.

The invention may utilize an enhanced interface to provide the various options to the sender and/or the receiver. For example, a sender may be provided with a listing of options in the form of pull down menus and radio buttons. Upon the sender making their various selections, the system presents a sender with a listing of the options selected (for approval by the sender) and stores the selected options as an “options set.” In a subsequent transaction, the sender is presented with the “options set” as well as prior options sets the sender has generated. The sender may then choose one of the options sets as is, choose and modify an options set, or simply start anew. Similar processing may be employed to present the receiver with options.

Various communications may be employed in the processing, such as e-mail, telephone, and text messaging. In one example, in conjunction with the processing described above, a text message is sent to the receiver's smart phone. The text message includes credentials to secure cash, such as via an ATM or into a direct deposit account, or via a wires transfer. A communication may then be sent to the sender advising them of the disposition of their requested transaction. Other communications may be used to advise either the sender or receiver of the status of a transaction or request approval of some action. Relatedly, the invention may leverage the presence of branch banks such as through ATM processing, teller interface, and in other ways.

Various other features are provided by the invention as described below.

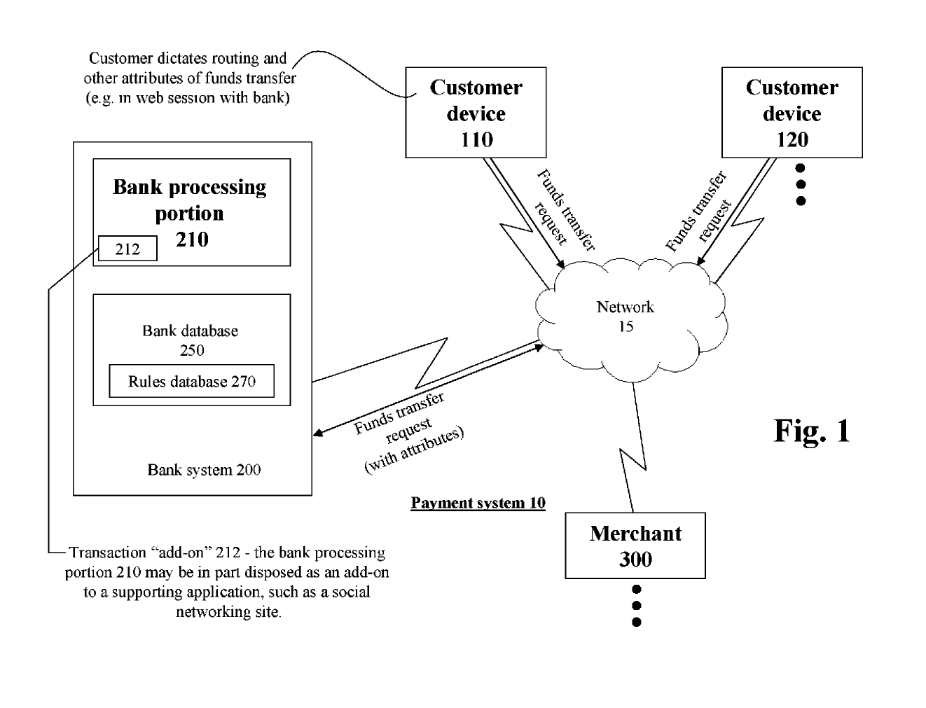

FIG. 1 is a block diagram of a payment system 10 in accordance with one embodiment of the invention. The payment system 10 includes a bank system 200, and plurality of customer devices (customer device 110, customer device 120, . . . ) as well as a plurality of merchants. The bank system 200, the customer devices (110 and 120), merchants 300, as well as other operating systems may communicate over a suitable network 15, such as the Internet, for example.

The bank system 200 includes a bank processing portion 210 and a bank database 250. The bank processing portion 210 performs various processing of the invention, as described herein. The bank processing portion 210 is in the form of a tangibly embodied computer processor.

The bank database 250 (of the bank system 200) contains various data used by or generated by the bank processing portion 210. In particular, the bank database 250 includes a rules database 270, as described below.

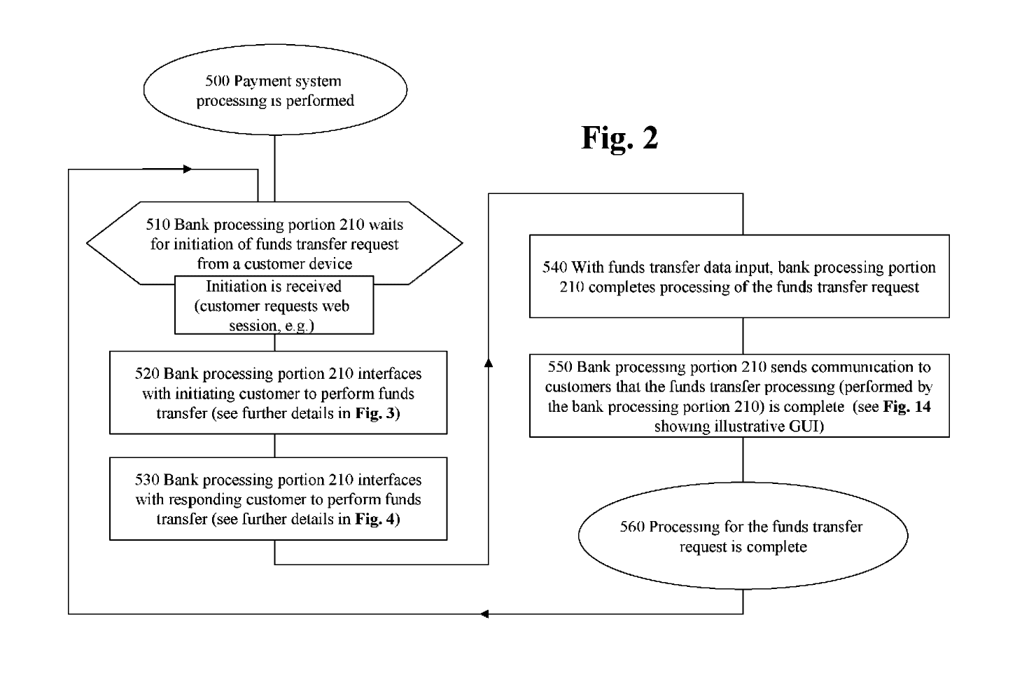

FIG. 2 is a high level flowchart showing features of the invention in accordance with one embodiment of the invention. As shown, processing of the invention starts in step 500 and passes to step 510.

In step 510, the bank processing portion 210 waits for an initiation of a funds transfer request from a customer device. In this example, that initiation is in the form of a request for a web session between the bank processing portion 210 and the customer device 110 (or alternatively the customer device 120). Once the customer request for a web session is received, the process of FIG. 2 passes to step 520.

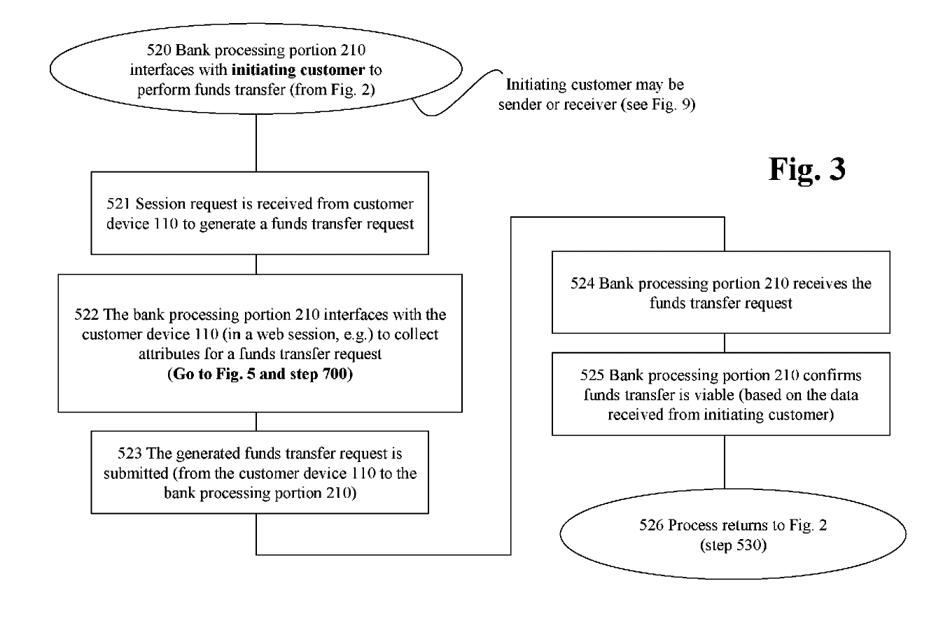

In step 520, the bank processing portion 210 interfaces with the initiating customer to perform funds transfer. The “initiating customer” as characterized herein may be either the sender of funds or the receiver of funds. Further details are described below with reference to FIG. 3.

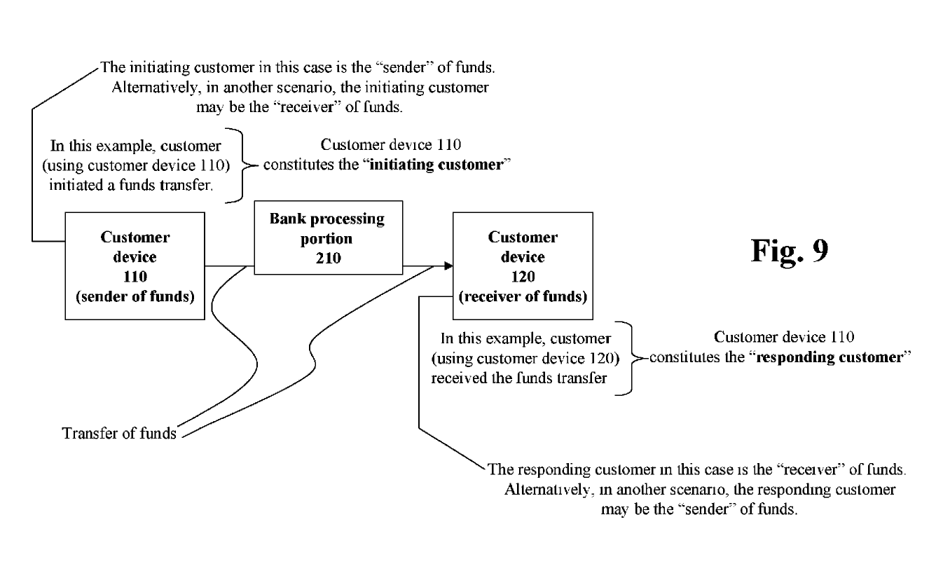

Relatedly, FIG. 9 is a diagram showing aspects of participants in a funds transfer, in accordance with one embodiment of the invention. That is, FIG. 9 illustrates the situation where the customer device 110 (interfacing with a human customer) constitutes the initiating customer. More specifically, the initiating customer 110 is requesting a transfer of funds from their account to the account of the responding customer. The responding customer interfaces with the system via the customer device 120. Accordingly, in this embodiment, the bank processing portion 210 first interfaces with the customer device 110 (to secure the funds transfer data) and thereafter, the bank processing portion 210 interfaces with the customer device 120 (to secure any further needed funds transfer data needed to complete the requested funds transfer)

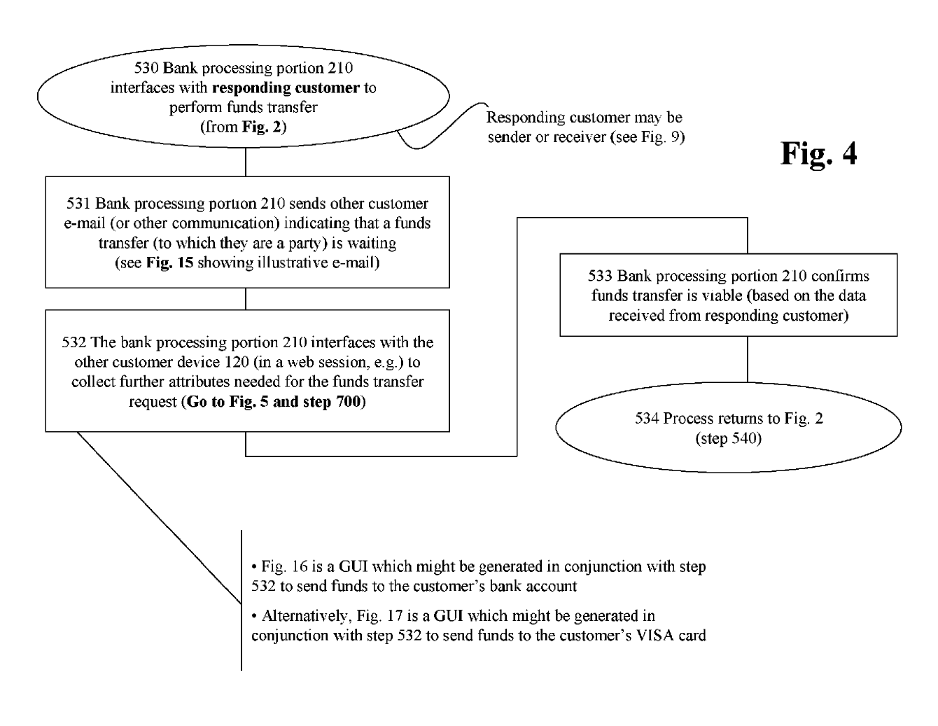

Returning to discussion of FIG. 2, after step 520, the process passes to step 530. In step 530, the bank processing portion 210 interfaces with the other customer, i.e., the responding customer to perform the funds transfer. The responding customer is the other of the sender or receiver, i.e., as compared to the customer who initiated the funds transfer. Further details are described below with reference to FIG. 4.

After step 530 of FIG. 2, the process passes to step 540. In step 540, with the funds transfer data input, the bank processing portion 210 completes processing of the funds transfer request.

Then, in step 550, the bank processing portion 210 sends a communication to the customer device 110 and/or the customer device 120 indicating that the funds transfer processing (performed by the bank processing portion 210) is complete. In accordance with one embodiment of the invention, such communications may indeed include credentials to one of the customers—such that the customer may use the credentials at some later time to secure the funds. For example, the credentials might include a password that the customer might enter at an ATM, so as to receive the funds, or alternatively, credentials to present to a teller at a banking facility.

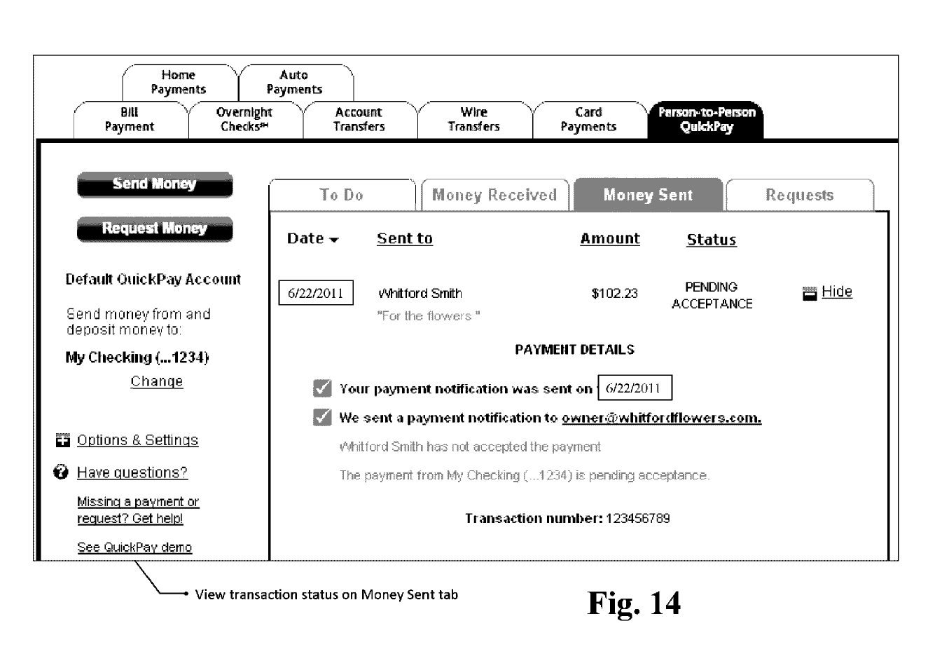

FIG. 14 is a GUI (graphical user interface) showing confirmation of a funds transfer, in accordance with one embodiment of the invention.

After step 550, the process of FIG. 2 passes to step 560. Step 560 of FIG. 2 reflects that the processing of the funds transfer is complete. After step 560, the process passes to step 510. Thereafter, the bank processing portion 210 waits for a request for a further funds transfer.

FIG. 3 is a flowchart showing further details of the “bank processing portion 210 interfaces with initiating customer to perform funds transfer” step 520 of FIG. 2, in accordance with one embodiment of the invention. The process of FIG. 3 starts in step 520, and passes to step 521.

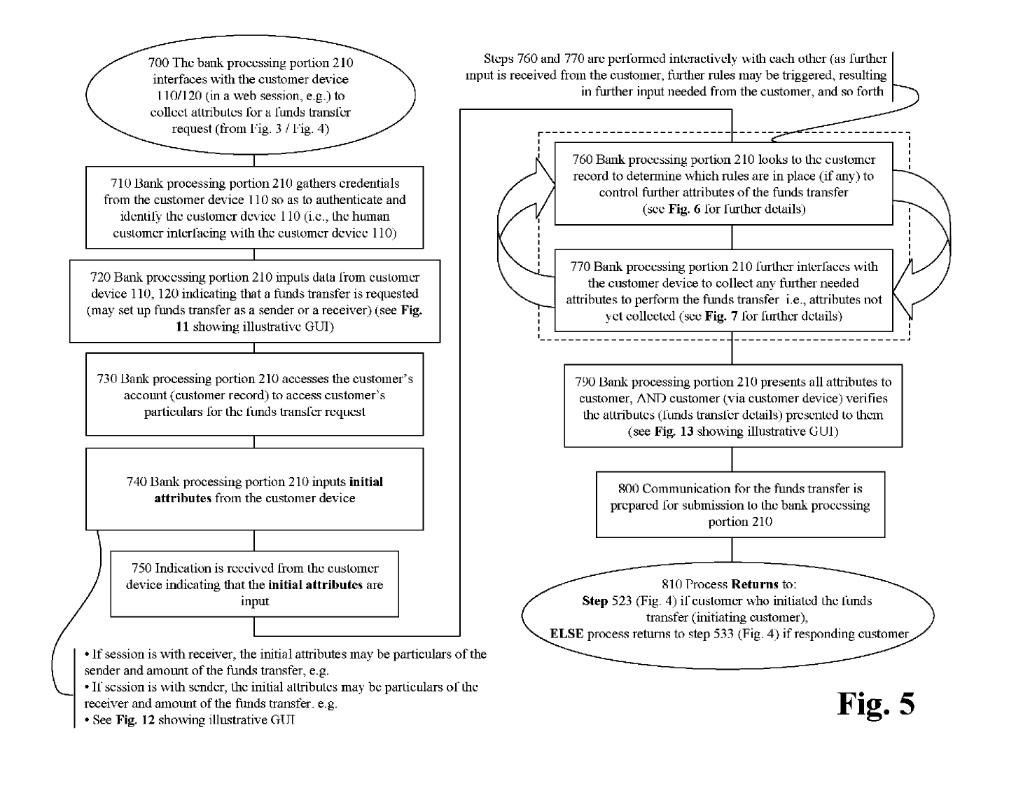

In step 521, a session request is received from the customer device 110 to generate a funds transfer request. Then, in step 522, the bank processing portion 210 interfaces with the customer device 110 (in a web session, for example) to collect attributes for the funds transfer request. Further details of the processing of step 522 are described below with reference to FIG. 5 (step 700).

After step 522, the processing of FIG. 3 passes to step 523.

In step 523, the generated funds transfer request is submitted, i.e., transmitted from the customer device 110 to the bank processing portion 210. Then, in step 524, the bank processing portion 210 receives the funds transfer request. In step 525, the bank processing portion 210 confirms that the funds transfer is viable, based on the data received from the initiating customer. In other words, based on the attributes established thus far in the processing, the bank processing portion 210 determines if the bank processing portion 210 can perform the transaction.

After step 525, the processing passes to step 526. In step 526, the process returns to FIG. 2 (step 530).

FIG. 4 is a flowchart showing in further detail the “bank processing portion 210 interfaces with the responding customer to perform funds transfer” step 530 of FIG. 2, in accordance with one embodiment of the invention.

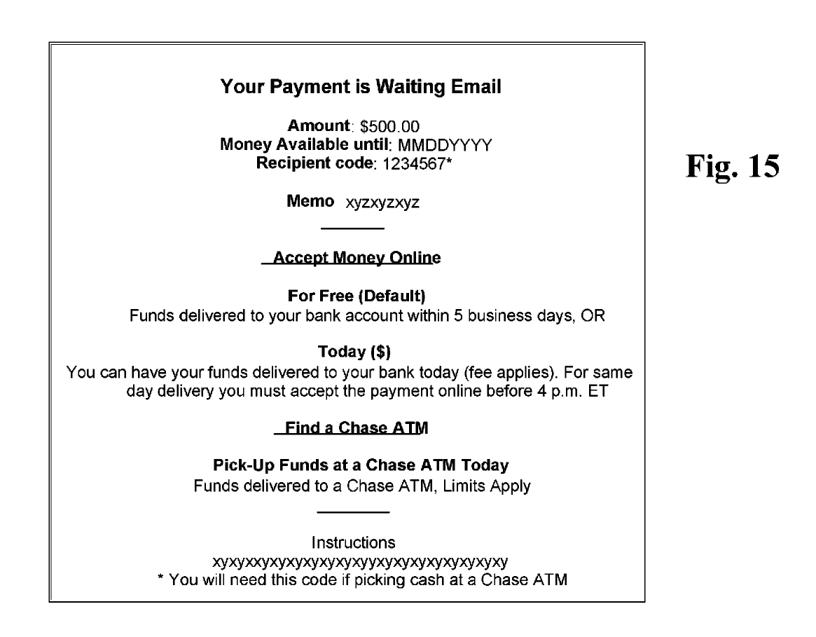

The process of FIG. 4 starts in step 530, and passes to step 531. In step 531, the bank processing portion 210 sends the other customer (either the customer device 110 or the customer device 120) a communication, such as an e-mail, for example. Such communication indicates to the customer that a funds transfer, to which they are a party, is waiting. FIG. 15 is a diagram showing the form and content of an illustrative e-mail, in accordance with one embodiment of the invention.

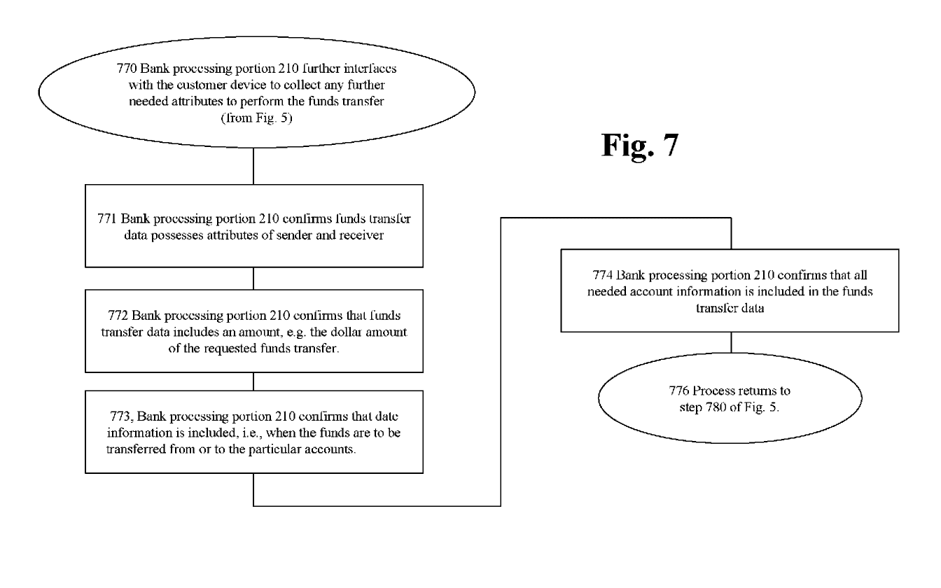

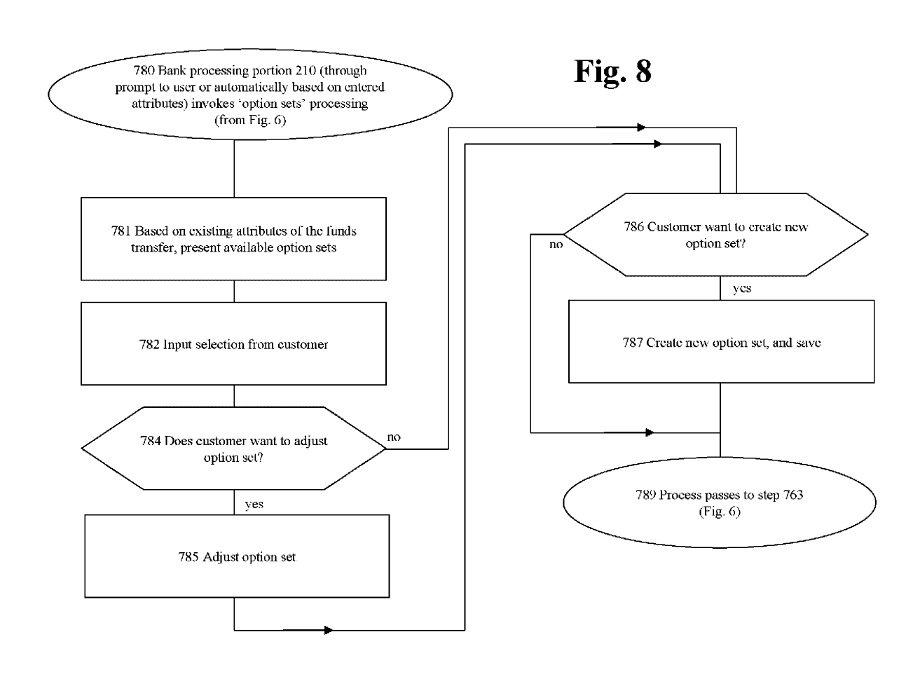

With further reference to FIG. 4, after step 531, the process passes to step 532. In step 532, the bank processing portion 210 interfaces with the other customer device 120 (in a web session, for example) to collect further attributes needed for the funds transfer request. Further details of the processing of step 522 are described below with reference to FIG. 5 (step 700). Accordingly, in accordance with this embodiment of the invention, both the funds transfer initiator and the funds transfer responder utilize the processing of FIG. 7, as well as FIG. 8 and FIG. 9.

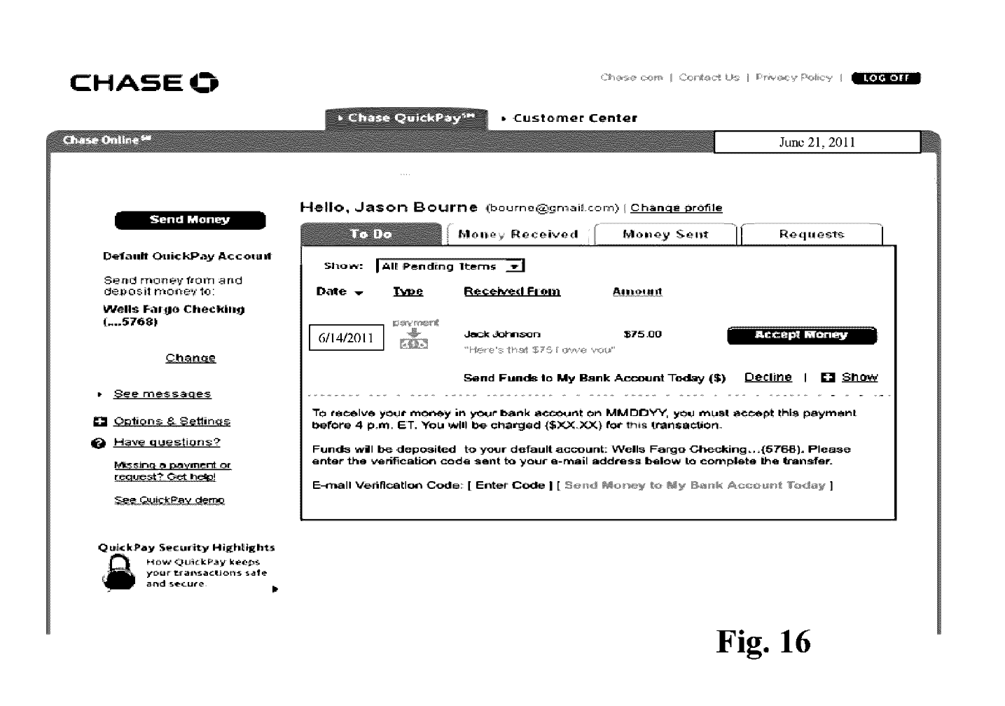

FIG. 16 is a GUI which might be generated in conjunction with step 532 to send funds to the customer's bank account, in accordance with one embodiment of the invention.

As shown in FIG. 16, the receiver (recipient) logs into the web site of the bank processing portion 210 to accept a payment. In this example, the customer selects a “Send funds to My Bank Account Today ($)” link. Clicking on the link expands and/or displays additional instructions and/or options to the customer. In accordance with embodiment of the invention, the user may be required to enter particular credentials to utilize particular options. For example, the user may be required to enter a verification code to initiate a wires transfer.

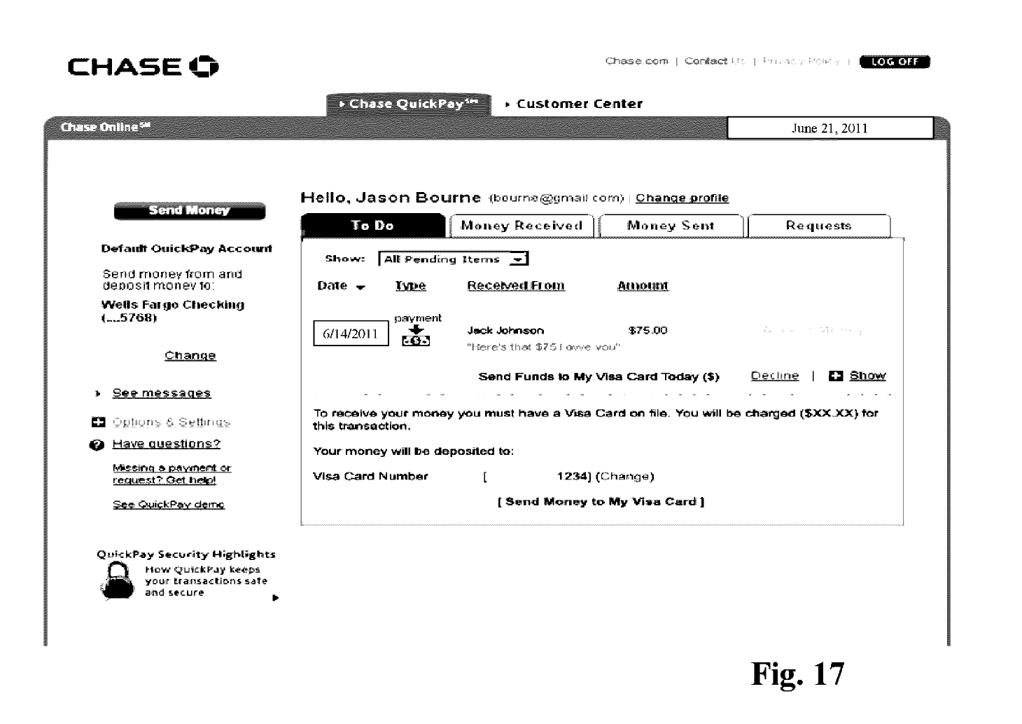

Alternatively, FIG. 17 is an illustrative GUI which might be generated in conjunction with step 532, to send funds to the customer's credit card , for example, in accordance with one embodiment of the invention.

As shown in FIG. 17, the receiver (recipient) logs into the web site of the bank processing portion 210 to accept a payment. The customer selects “Send funds to Visa Card Today($)” link. Clicking on the link expands and/or displays additional instructions. As noted above, in accordance with embodiments of the invention, the user may be required to enter particular credentials to utilize particular options. For example, the user may be required to enter credentials to use a particular credit card.

Returning now to FIG. 4, after step 532 of FIG. 4, the process passes to step 533. In step 533, the bank processing portion 210 confirms that the funds transfer is viable (based on the data received from the responding customer).

Then in step 534, the process returns to FIG. 2 (step 540).

FIG. 5 is a flowchart showing in further detail the “bank processing portion interfaces with the customer device to collect attributes for a funds transfer request” processing of FIG. 3 and FIG. 4, in accordance with one embodiment of the invention. That is, the processing of FIG. 5 may be implemented from either FIG. 3 or FIG. 4. As described above, the processing of FIG. 5 may be implemented in a web session between the bank processing portion 210 and the customer device, However, other channels of interface may alternatively be utilized.

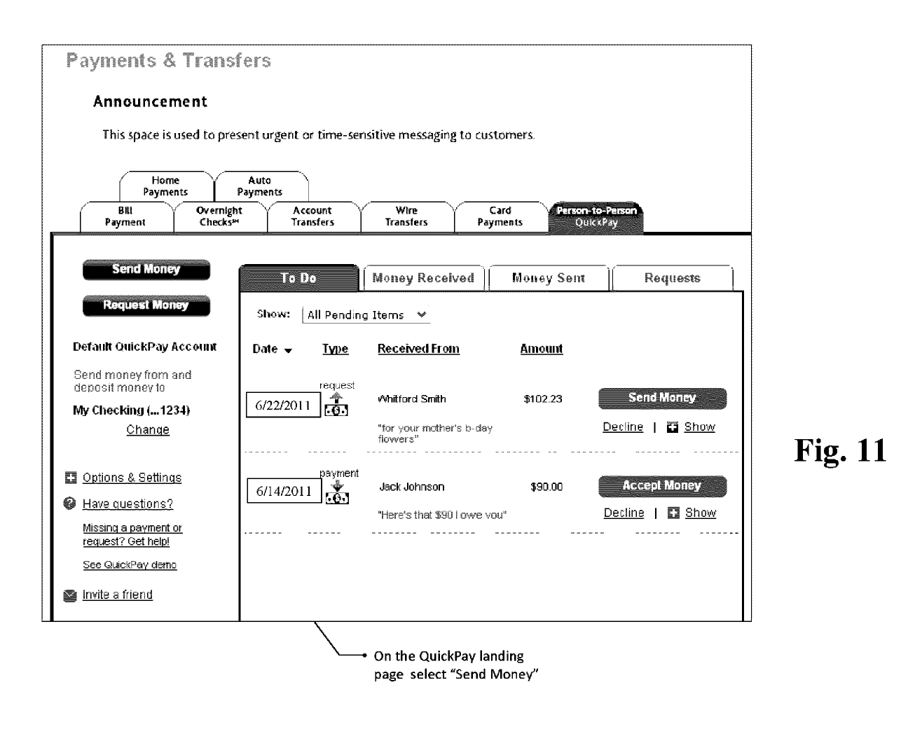

The processing of FIG. 5 starts in step 700 and passes to step 710. In step 710, the bank processing portion 210 gathers credentials from the customer device 110 so as to authenticate and identify the customer device 110 (i.e., the human customer interfacing with the customer device 110). Then, in step 720, the bank processing portion 210 inputs data from customer device indicating that a funds transfer is requested. As noted above, step 720 may be in the form of setting up a funds transfer as a sender or a receiver. FIG. 11 is an illustrative GUI in which the customer may prompt the bank processing portion 210 to “send money” in accordance with one embodiment of the invention.

After step 720, the process passes to step 730. In step 730, the bank processing portion 210 accesses the customer's account (customer record) to access the customer's particulars, i.e., to access the data that will be needed to perform the funds transfer request.

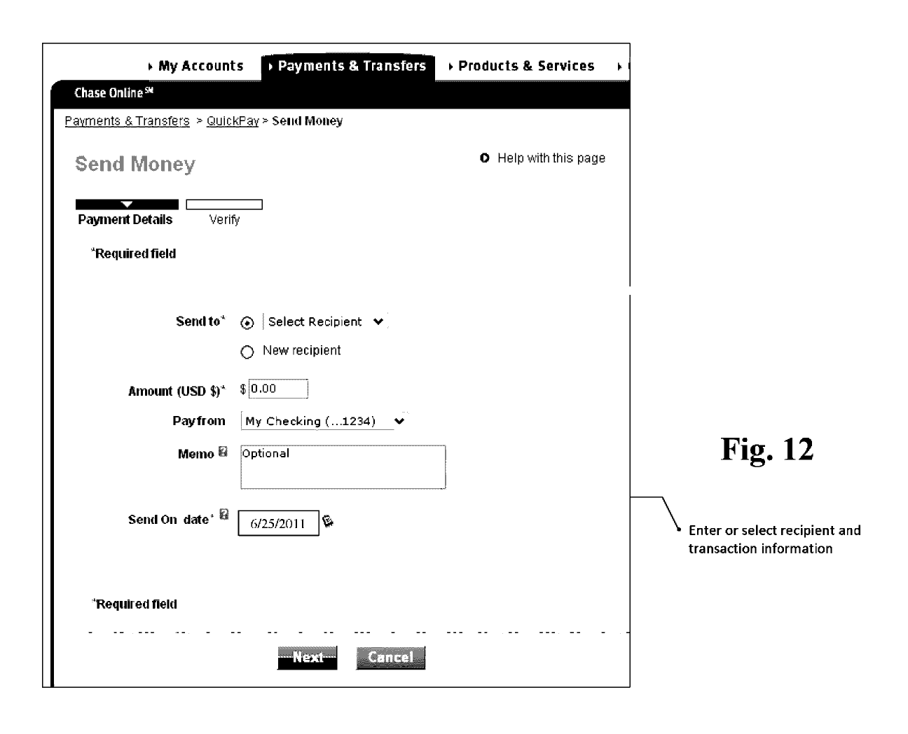

Then, in step 740, the bank processing portion 210 inputs initial attributes from the customer device. For example, the session is with a receiver of funds, then the initial attributes may be particulars of the sender and amount of the funds transfer, for example. On the other hand, if the particular session is with a sender, the initial attributes may be particulars of the receiver and amount of the funds transfer, for example. FIG. 12 is an illustrative GUI showing details of a customer entering payment details such as recipient name, nickname, amount, pay from account and/or send on date, for example.

After step 740, the process passes to step 750. In step 750, the bank processing portion 210 receives input from the customer device indicating that the initial attributes are input. Such initial attributes may be very minimal in accordance with one embodiment of the invention, such as simply that the customer wishes to perform a funds transfer, i.e., a transaction. On the other hand, the initial attributes may specify particulars of the funds transfer with substantial detail

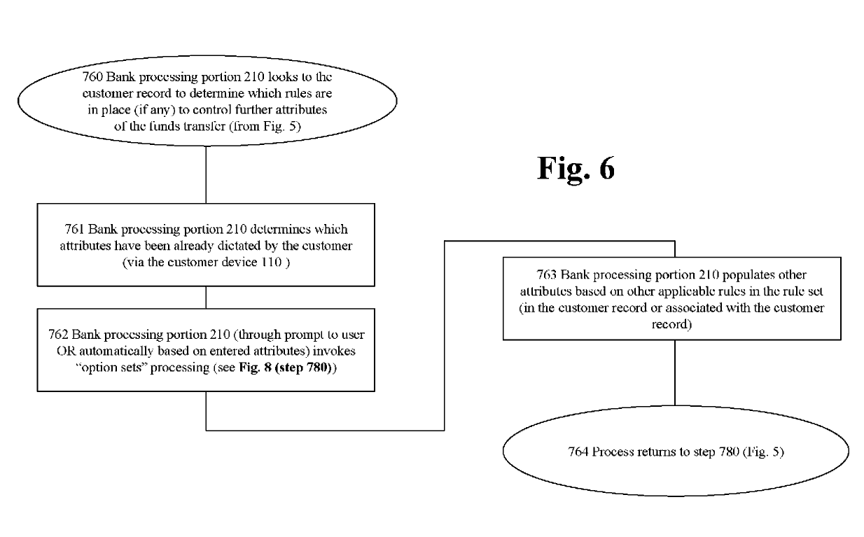

After the initial attributes are input from the customer in step 750, the processing passes to steps 760 and 770. As shown in FIG. 5, steps 760 and 770 are performed interactively with each other. That is, in step 760, the bank processing portion 210 looks to determine which rules are triggered based on the particulars of the initial attributes gathered from the customer. As rules are triggered and further populate the funds transfer data, then it may be the case that further information may be required by the customer, which in turn may generate further rules being triggered. More specifically, in step 760, the bank processing portion 210 looks to the customer record to determine which rules are in place (if any) to control further attributes of the funds transfer. FIG. 6 shows further details of this processing. Further, in step 770 of FIG. 5, the bank processing portion 210 further interfaces with the customer device 110 to collect any further needed attributes to perform the funds transfer, i.e., attributes not yet collected. FIG. 7 shows further details of this processing.

Accordingly, as described above, the processing of steps 760 and 770 may be performed interactively and iteratively with each other until the data needed to effect the requested funds transfer is collected. In accordance with one embodiment of the invention, the bank processing portion 210 may identify this termination of the processing of steps 760, 770 by identifying that all needed parameters have been satisfied and/or that all options have been selected, for example.

Then, in step 790, the bank processing portion 210 presents all attributes to the customer (via the customer device) and the customer verifies the attributes, i.e., the funds transfer details.

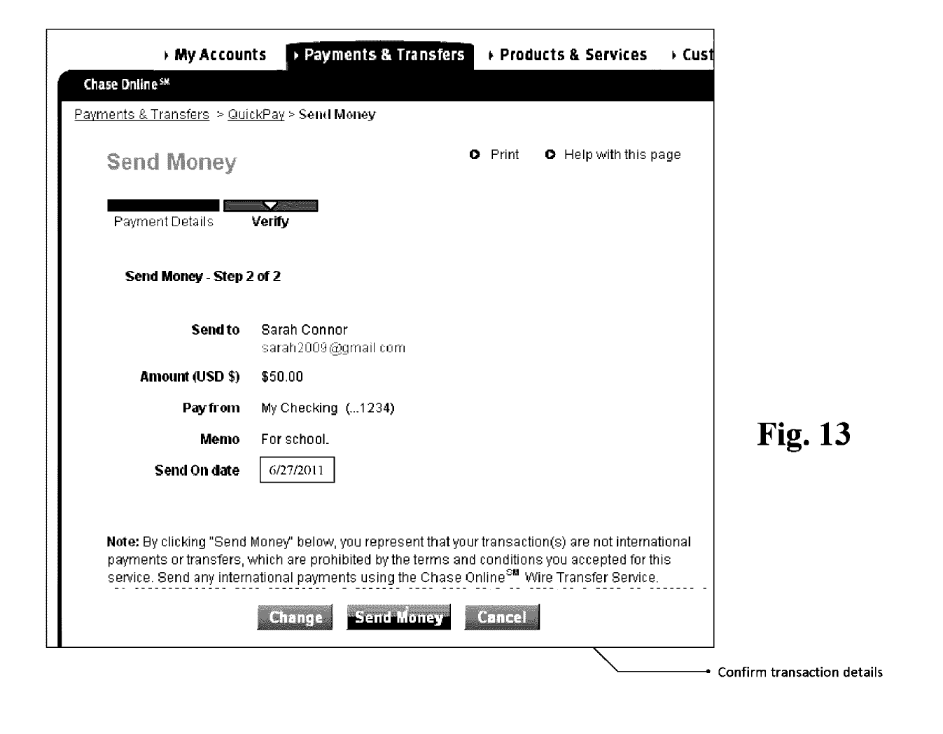

FIG. 13 is a GUI presented to the customer to verify details of the funds transfer in accordance with one embodiment of the invention. It is appreciated that the content and format of the GUIs described herein may vary as desired.

After step 790, the process passes to step 800. In step 800, the communication for the funds transfer is prepared for submission (from the customer device) to the bank processing portion 210. In step 810, the process returns to step 523 (FIG. 4) if the processing is being performed with the customer who initiated the funds transfer. On the other hand, the process returns to step 533 (FIG. 4) if the processing is being performed with the customer who is responding to another (customer) initiating the funds transfer.

FIG. 6 is a flowchart showing in further detail the “bank processing portion 210 looks to the customer record to determine which rules are in place (if any) to control further attributes of the funds transfer” step 760 of FIG. 5, in accordance with one embodiment of the invention.

As shown, the process starts in step 760, and passes to step 761.

In step 761, the bank processing portion 210 determines which attributes have been already dictated by the customer (via the customer device 110). Then, in step 762, the bank processing portion 210 (either through a suitable prompt to the customer, i.e., the user, or automatically based on the attributes entered by the customer) invokes “option sets” processing. Further details are described below with reference to FIG. 8.

After step 762, the process passes to step 763. In step 763, bank processing portion 210 fills in other attributes based on other applicable rules in the rule set. In accordance with one embodiment of the invention, the particulars of the rule set are indeed disposed in the customer record. On the other, or in combination with, the customer record may in some manner be linked to the rule set, or in some other manner associated.

After step 763, the process passes to step 764. In step 764, the process returns to step 780 of FIG. 5.

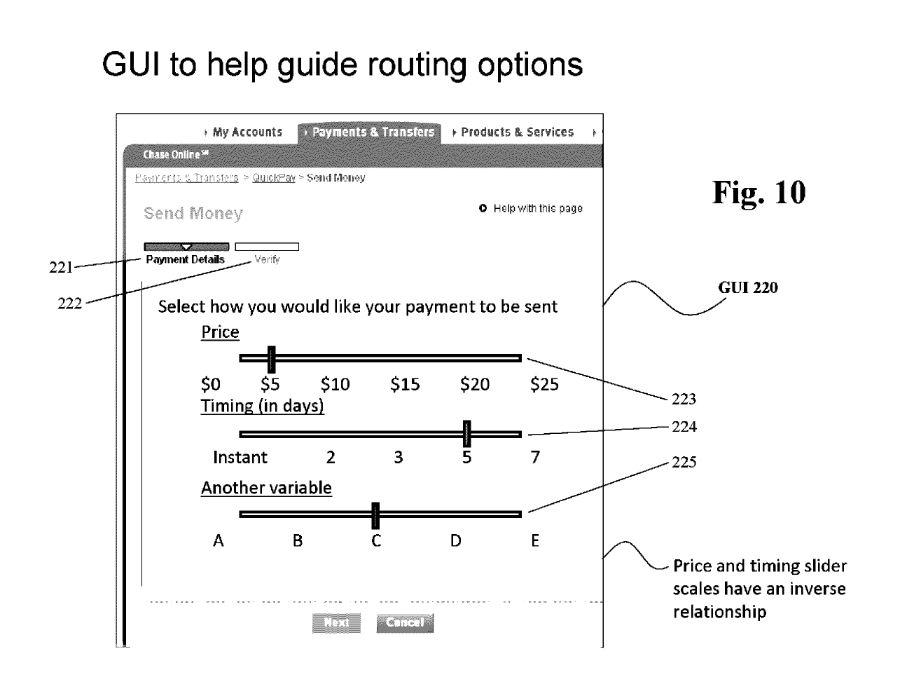

FIG. 10 is an illustrative GUI (graphical user interface) 220 in which the customer may control routing options for a funds transfer (i.e., a transaction) in accordance with one embodiment of the invention. The GUI 220 of FIG. 10 might be invoked in conjunction with the processing of FIG. 5 and/or with other options processing described herein.

As shown, in interfacing with the GUI 220 of FIG. 10, the customer selects whether they wish to work with “payment details” (221) or to “verify” (222) the particulars of a transaction As shown in FIG. 10, the customer has opted to work with “payment details.”

As shown, the customer is provided with slide scales. In accordance with one embodiment of the invention, the slide scales include a price scale 223, a timing scale 224, and an “another variable scale” 225. The customer may slide the particular scale to adjust the associated parameter. It is appreciated that any of a wide variety of parameters may be controlled by the customer, i.e., as reflected by the “another parameter” slide 225. The controlled parameters might relate to, for example: amount of funds transferred; timing of the transaction; costs associated with the transaction; accounts involved in the transaction; the manner in which the transaction is routed, i.e., such as what channel; whether any holds are placed on the transaction (as further described below); as well as any other parameter, as desired. For example, further parameters that could be used and/or presented in the manner of FIG. 10 are parameters relating to routing of payments, how returns could be handled, network/payment channel routing, other timing parameters, and notification before debit, for example.

As described below in further detail, least cost routing processing may be utilized in embodiments of the invention. Accordingly, a customer may initially select the particular parameters of the desired transaction using the GUI of FIG. 10. Once the customer selects the desired parameters, in accordance with one embodiment of the invention, the bank processing portion 210 then automatically applies various other parameters needed in performing the transaction. In particular, parameters that may be automatically implemented are the least cost routing parameters as described below.

Further, it is appreciated that there may be some association between scales presented to the customer. For example, a scale which conveys how quickly the transaction will be processed may be tied into a scale that conveys the cost of the transaction to the customer. Thus, as time decreases, then cost to the customer may increase. Other associations (i.e., interplay) between options may be utilized as desired.

FIG. 7 is a flowchart showing in further detail the “bank processing portion 210 further interfaces with the customer device to collect any further needed attributes to perform the funds transfer” step 770 of FIG. 5, in accordance with one embodiment of the invention. The process of FIG. 7 starts in step 770, and passes to step 771.

In step 771, the bank processing portion 210 confirms that the funds transfer data possesses attributes of sender and receiver, i.e., the funds transfer data specifies a sender and a receiver.

In step 772, the bank processing portion 210 confirms that the funds transfer data includes an amount, e.g. the dollar amount of the requested funds transfer.

In step 773, the bank processing portion 210 confirms that date information is included, i.e., when the funds are to be transferred “from” or “to” the particular accounts.

Lastly, in step 774, the bank processing portion 210 confirms that all needed account information is included in the funds transfer data.

It is appreciated that various other information may be confirmed depending on the particular nature of the funds transfer, as well as other parameters.

After step 774 of FIG. 7, the process passes to step 776. In step 776, the process returns to step 780 of FIG. 5.

FIG. 8 is a flowchart showing in further detail the “bank processing portion 210 (through prompt to user or automatically based on entered attributes) invokes ‘option sets’ processing” step 780 of FIG. 6, in accordance with one embodiment of the invention.

The process starts in step 780, and passes to step 781. In step 781, based on the attributes already entered by customer, the bank processing portion 210 determines which option sets are available to the particular customer and/or queries the customer whether they would like to create a new option set

In step 782, the bank processing portion 210 inputs the selection, i.e., the choice, from the customer as to which option set they wish to select. After step 782, the process passes to step 784. In step 784, the bank processing portion 210 queries the customer as to whether they want to adjust the particular option set, or some other option set. If yes, then the process passes to step 785, in which processing is performed to adjust the option set—through the bank processing portion 210 interfacing with the customer. On the other hand, if no in step 784, the process passes to step 786.

In step 786, the bank processing portion 210 queries the customer as to whether they want to create a new option set. If yes, then the process passes to step 785, in which processing is performed to create the new option set—through the bank processing portion 210 interfacing with the customer. After step 787, the process passes to step 789. On the other hand, if no in step 786, then the process passes directly to step 789.

In step 789, the process passes to step 763, i.e., the processing returns to FIG. 6.

Hereinafter, further aspects of the invention are described.

In accordance with embodiments of the invention, it is appreciated that various communications may be sent (or received) from the sender, receiver, some other customer, or some other entity, for example. For example, such communications might be confirmation of action taken or confirmation of an event that has taken place, for example. In general, the systems and methods of the invention may utilize a wide variety of channels to both effect the transaction itself, as well as to transmit related communications.

In accordance with embodiments of the invention, it is appreciated that various codes or other user credentials may be used in conjunction with features described herein. For example, the sender, receiver, or some third party may be provided with a code, which the customer is required to enter, in order to perform a particular action. The particular action might be to authorize the sending or receiving of funds or some other action. Further, aliases may be used in conjunction with associations between customers and transactions, or in conjunction with other associations.

In accordance with one embodiment of the invention, a sender of funds may perform processing to the benefit of a receiver of funds. Illustratively, in one example, a first customer owes a payment to a utility company. An “affiliated customer” wants to make a payment to the utility company on behalf of the first customer. For example, the affiliated customer might be the granddaughter of the first customer. In accordance with one embodiment of the invention, information is provided from the first customer to the affiliated customer regarding particulars of the payment to the utility company. Using this information, the bank processing portion 210 allows for the affiliated customer to make a payment on behalf of the first customer. In embodiments, various confirmations and other communications may be utilized, as well as associations between the utility company, the first customer and the affiliated customer, and the various billing particulars involved. For example, the first customer may request that billing information be forwarded automatically on to the affiliated customer, i.e., her daughter, and/or the first customer might forward the billing particulars to the affiliated customer. For example, the grandmother takes a picture of a bill she owes, and sends the picture to the granddaughter. There may be provided codes on the bill (or other information) that allow the granddaughter to “set things up” in accord with this example. For example, the granddaughter may be provided to interface with the bank processing portion 210 in a web session to pay the bill (for a grandmother) a single time, set up recurring payments, work with different currencies, and/or set up further options. Accordingly, such arrangement provides for the affiliated customer to make payments (on behalf of the first customer) to a payment receiver, i.e., in this example the utility company.

In accordance with a further embodiment of the invention, the bank processing portion 210 may assist a first customer in providing for an affiliated customer to perform a “pick-up” in lieu of the first customer, i.e., in some manner transfer delivery of an item over to the affiliated customer. Thus, such processing allows for someone else to pick up an item on behalf of the first customer. This might be desired if the first customer is unavailable at a particular location during a delivery window that is offered. The bank processing portion 210, interfacing with the first customer and/or the second customer, may provide for such by providing credentials, information, aliases or other particulars as needed. The assigned delivery may be an ongoing authority or just for a single occurrence time.

In the “payment on behalf of another” and the “pick-up for another” examples above, as well as for the other examples described herein, it is appreciated that various mechanisms, including safeguards may be employed. For example, participating customers may need to provide authentication to show who they are and to confirm that they are authorized to take a particular action. Relatedly, registration with the bank processing portion 210 (or other entity) may be required. Participating customers may be provided with the option to say “no” so as to opt-out of a particular action. Relatedly, participating customers may be provided with an “accept” mechanism—to signify their acceptance of a particular action. Further, mechanisms may be provided to allow payments or items to sit in “queue.” That is, processing of the delivery of funds or the delivery of an item, for example, may be put in queue, so as to wait for action of a particular customer (or customers), or to wait for some other event to occur. Relatedly, it is appreciated that the delivery of funds or the delivery of an item may be broken up and subdivided into portions. For example, a grandmother may effect payment to her three grandsons, who can respectively pick up their portion of the payment at their respective convenience.

In accordance with embodiments of the invention, an “escrow” feature may be utilized by the participating customers. In other words, one of the participating customers may effect a “hold” on a transfer of funds, for example. Accordingly, with this feature, one of the participating customers may dictate that a transfer of funds or some other action is “conditional” on a particular event, i.e., in satisfaction of the condition. The event might be a particular communication from the sender, a particular communication from the receiver, a particular communication from some other party, a communication triggered by the delivery of an item, the occurrence of an event, or the non-occurrence of an event, for example. Thus, release of the condition may be satisfied by a FedEx delivery, and a related communication associated therewith; the occurrence of some other event (such as securing the winning bid on EBay); a customer running their credit card or driver's license at a particular terminal or location; a particular time period elapsing; a particular time/date being attained; or by not “hearing from” a particular person or entity, for example. The escrow feature may be used for a customer to fully set up a transaction, and condition the transaction on that customer's future “ok.” Thus, the customer could set up the transaction, and then trigger performance of the transaction with a tap of her mobile phone, for example. Relatedly, the bank processing portion 210 may utilize the escrow feature to perform recurring payments, e.g. the arrival of a particular day in each month is the event that triggers the transaction. Some aspects of a particular transaction may be conditional on the sender and other aspects conditional on the receiver of funds. Indeed, in accordance with embodiments of the invention, a variety of events may respectively (1) trigger the imposition of the condition, and/or (2) satisfy the condition, i.e., so as to release the condition. In accordance with embodiments of the invention related to the escrow feature, the bank processing portion 210 may both impose the condition and release the condition once satisfied. Further, or in conjunction with conditional processing performed by the bank processing portion 210, some third party may both impose the condition and release the condition once satisfied. In other words, a third party could be imposed between and sender and the receiver, so as to release funds once an imposed condition has been satisfied. Illustratively, in the context of purchase of tickets, the funds might be put in escrow until both (1) the sender verifies she has sent the tickets, and (2) the purchaser verifies that she has received the tickets, and (3) verification is provided that funds have been received from the purchaser. Such example illustrates multiple and sequential triggers to release the funds in escrow.

Relatedly, it is further appreciated that the condition to release the funds (or to perform some other step in the processing of the transaction) might be the input of particular credentials from the sender, receiver, and/or some other person or processing portion. For example, the credentials might be disposed in a digital token, secure key, token on a smart phone, FOB on a key chain, transmitted to a smart phone, disposed on some other electronic device, or disposed in some other manner. Accordingly, the credentials might be electronically transmitted to a further device and/or the credentials might be read by the customer and manually entered into a further device, for example, i.e., so as to satisfy the condition. That is, input into such further device would effect the further processing of the transaction (which was conditional upon the credentials) by the transaction system,

Hereinafter, further embodiments of the invention will be described. As set forth herein, the bank processing portion 210 interfaces with a customer device 110 to provide a variety of functionality, including in particular effecting transactions, e.g., payments, from a first customer to a second customer. For example, such functionality is set above with reference to the flowcharts of FIGS. 2-9. In some embodiments of the invention, such functionality (or a portion of such functionality) may be provided by an “add-on” to some other application. As used herein, an “add-on” means software or a collection of software that runs in conjunction with a supporting application and that adds particular capabilities to the supporting application, so as to customize the functionality of the supporting application. For example, one type of “add-on” is a “plug-in.” More specifically, a “transaction add-on” as described herein (and reflected in FIG. 1) means an add-on that provides select functionality set forth herein, while interfacing with a bank processing portion 210, i.e., such that the transaction add-on 212 and the bank processing portion 210 collectively provide the functionality as described herein. It is appreciated that the particular functionality provided by the transaction add-on 212 vis-à-vis the particular functionality provided by the bank processing portion 210 constitutes a matter of design choice based on various parameters such as security concerns, volume of transactions, dollar amount of transactions, communication capabilities, and other parameters. For example, in accordance with one embodiment of the invention, it may be the case that substantially all the processing described herein is provided by the transaction add-on 212 with only select data storage and retrieval being performed by the bank processing portion 210.

Illustratively, a transaction add-on, in accordance with the invention, may be added with a social networking site, such as FACEBOOK OR LINTKEDlN, so as to provide functionality as set forth herein. In accordance with one embodiment of the invention, the functionality of the add-on may be triggered by the user selecting a button that is displayed on the social networking site. Upon the user selecting the button, functionality of the add-on is launched after the user enters appropriate credentials, such as username and password. Alternatively, no further credentials may be required, i.e., the transaction add-on 212 relies on the security of the user logging onto the social networking site itself. For example, the transaction add-on 212 may generate a GUI (graphical user interface) that affords the user functionality as desired. It is appreciated that the systems and methods described herein may be used in conjunction with any of the features described in U.S. patent application Ser. No. 12/858,650 filed Aug. 18, 2010 and entitled “Social Networking Payment System and Method”, the contents of which are incorporated herein by reference in their entirety.

The transaction add-on 212 may utilize attributes of the supporting application. For example, a social networking site may utilize a particular “user identifier” for each user of the social networking site, e.g. a “social networking identifier.” The user identifier may typically be in the form of a character string, such as an alphanumeric character string. The transaction processing performed by the transaction add-on 212 may work off of such user identifiers. For example, the user identifier of a particular user may be associated with particular financial accounts of the user in the bank system 200. In accordance with one embodiment of the invention, the transaction add-on 212 may input a request for a transaction (as described herein) and effect the transaction using the user identifier of the other user, i.e., the receiver or the sender of funds, for example. Such use of the user identifier might include the transaction add-on 212 routing credentials to a receiver via the social networking site and/or sending or posting a message advising the receiver that funds are available. Various notices, postings and/or confirmations may be provided in conjunction with performing the transaction. For example, the transaction add-on might be a plug-in to FACEBOOK, and might post a message to the “wall” of friends of both the receiver and the sender. Such message might reveal details as desired. For example, the message or posting might simply indicate that the transaction was performed between the sender and the receiver, but not provide any details of the transaction. The transaction add-on 212 may generate indicia (such as a logo) on the user's page, i.e., the user's page on the social networking site. The indicia may indicate that the user is open to such transaction processing.

In accordance with one embodiment of the invention, the transaction add-on 212 may collect/harvest the user identifier of each friend of the user, i.e., the user who opted to add (or enable) the transaction add-on 212. The user identifier for each of the user's friends would then be available as needed. On the other hand, such collection of each user's user identifier might be done as needed. For example, in accordance with one embodiment of the invention, the user initiating the transaction may click on the picture (or other representation) of the person with which they wish to do the transaction. The transaction add-on 212 would then retrieve the information (from the social networking site) that is needed to perform the transaction. In particular, the transaction add-on 212 would retrieve the user identifier of the other user.

In accordance with additional embodiments of the invention, the bank processing portion 210 may further utilize email information of both the sender of funds and/or the receiver of funds.

In one illustrative scenario, Amity sends Kathi a payment through the bank system 200, i.e., the bank processing portion 210 (and the particular banking program(s) that the bank processing portion 210 supports, such as a quick pay program). Amity has previously set Kathi up as a recipient using Kathi's email (which Kathi previously provided to the bank processing portion 210). Accordingly, Kathi and Amity are both enrolled in the bank processing portion 210. Upon receiving Amity's request to send the payment (using Kathi's email), the bank processing portion 210 performs processing to identify that Kathi and Amity are indeed both enrolled. As a result, Amity doesn't have to specifically say “send this payment utilizing the bank processing portion 210 (and the particular banking program that the bank processing portion 210 supports). Rather, such processing may be performed automatically as a least cost routing of those routing options available and/or based on other specified parameters. Email information may also be used to provide various notification and/or confirmation information, for example.

In accord with the above described processing using email information, the sender of funds and/or the receiver of funds provides their email information to the bank processing portion 210 (or a processing system associated with the bank processing portion 210 from which the email information can be retrieved). If the particular customer has an account with the particular entity, then the email information might be provided in their customer account information, such as in their profile information. However, it is appreciated that it is not needed for the customer to have an account. That is, it may be that the customer simply registers in order to perform transaction processing with the bank processing portion 210, i.e., without having an account with the particular financial entity. In conjunction with the registration process, the customer may provide basic contact information (including their email) as well as information regarding their financial account with some other entity. It is appreciated that processing a transaction in the situation where one or more customers do not have an account with the particular financial entity may be beneficial, in particular, in the context of a supporting application as described herein, e.g. in the context of a social networking site. However, in accordance with some embodiments of the invention, it may be desired that at least one customer indeed possesses an account with the particular financial entity.

It is appreciated that some customers may opt not to provide their email information for privacy reasons or otherwise. However, a customer may opt to provide email information so as to use the functionality described herein. Upon sign-up with the financial entity (either to set up an account or simply to register as described above), the customer may be presented with terms and conditions that control the particular processing that will take place under particular situations. For example, the terms and conditions may dictate that anytime the bank receives money for that person with the registered email attached to it, the bank will effect the transaction electronically using the registered email. The use of email information as described herein may result in more collection of email/mobile phone data for each recipient, even outside of the particular financial entity. This may be beneficial to the customer as well as the financial entity.

A customer might be further prompted to provide their email information for further reasons including the customer is familiar with the processing and wants to take advantage and utilize such processing; the customer observes their friends using such processing; and/or the email information was obtained from the customer in the course of setting up and account or in the course of setting up a registration with the particular financial entity.

It is appreciated that any feature described herein may be used in conjunction with any other feature, as desired.

As described above, the invention relates to processing to perform transfer of funds from one person to another person, i.e., “P2P” transactions. However, the invention is not limited to such. That is, the features as described herein may also be utilized in the context of business to business, business to person, person to business, and/or between other entities. Hereinafter further aspects of implementation will be described.

As described above, embodiments of the system of the invention and various processes of embodiments are described. The system of the invention or portions of the system of the invention may be in the form of a “processing machine,” i.e. a tangibly embodied machine, such as a general purpose computer or a special purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as any of the processing as described herein. Such a set of instructions for performing a particular task may be characterized as a program, software program, or simply software.

As noted above, the processing machine, which may be constituted, for example, by the particular system and/or systems described above, executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general purpose computer. However, the processing machine described above may also utilize (or be in the form of) any of a wide variety of other technologies including a special purpose computer, a computer system including a microcomputer, mini-computer or mainframe for example, a programmed microprocessor, a micro-controller, a peripheral integrated circuit element, a CSIC (Consumer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, embodiments of the invention may include a processing machine running the Microsoft Windows™ Vista™ operating system, the Microsoft Windows™ XP™ operating system, the Microsoft Windows™ NT™ operating system, the Windows™ 2000 operating system, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform. It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing as described above is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, or any client server system that provides communication, for example. Such communications technologies may use any suitable protocol such as TCP/IP, UDP, or OSI, for example. As described above, a set of instructions is used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, ROM Visual Basic, and/or JavaScript, for example. Further, it is not necessary that a single type of instructions or single programming language be utilized in conjunction with the operation of the system and method of the invention. Rather, any number of different programming languages may be utilized as is necessary or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, a EPROM, a wire, a cable, a fiber, communications channel, a satellite transmissions or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, voice reader, voice recognizer, dialogue screen, menu box, list, checkbox, toggle switch, a pushbutton or any other device that allows a user to receive information regarding the operation of the processing machine as it processes a set of instructions and/or provide the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications and equivalent arrangements.

1. A processing system that performs a funds transfer between a first customer and a second customer, the processing system tangibly embodied in the form a computer, the processing system including:
a bank processor that performs processing in conjunction with the funds transfer; and
a bank database which contains data used in the funds transfer; and
the bank processor, coupled to the bank database, performing processing including:
inputting a funds transfer request from the first customer through interfacing with the first customer, the bank processor providing a plurality of options to the first customer via an interactive interface that controls each option of the plurality of options,
generating, by the bank processor, first attributes of the funds transfer based on the options that are selected by the first customer initiating the funds transfer;
interfacing with the second customer, receiving the funds transfer from the first customer, including providing a plurality of options to the second customer, the plurality of options provided to the second customer comprising (i) an option to receive the funds for a fee on the same day that the second customer selects the options and (ii) an option to receive the funds for free on a subsequent day that the second customer selects the options;
generating, by the bank processor, second attributes of the funds transfer based on the options that are selected by the second customer;
aggregating the first attributes and the second attributes to generate aggregated attributes; and
performing the funds transfer based on the aggregated attributes.

2. The system of claim 1, the bank processor, prior to interfacing with the second customer, sending a communication to the second customer alerting the second customer of the funds transfer requested by the first customer.

3. The system of claim 2, wherein the communication to the second customer is in the form of an e-mail.

4. The system of claim 1, the interfacing with the first customer including the bank processor presenting the first customer with at least one option set, the option set generated based on attributes entered by the first customer, and each option set contains a plurality of attributes that the first customer may choose as a set.

5. The system of claim 4, wherein the bank processor presents the first customer with a plurality of option sets.

6. The system of claim 5, wherein the bank processor provides the first customer the option to change the attributes in at least one option set.

7. The system of claim 6, wherein the bank processor provides the second customer with a plurality of option sets.

8. The system of claim 7, wherein the bank processor provides the second customer the option to change the attributes in at least one option set.

9. The system of claim 5, wherein the bank processor presents the first customer with the capability to create a new option set.

10. The system of claim 1, wherein the processing of the bank processor is performed with the first customer constituting a sender of funds and the second customer constituting a receiver of funds.

11. (canceled)

12. The system of claim 1, the system being constituted by an add-on to a supporting application.

13. The system of claim 12, the add-on constituted by a plug-in, and the supporting application constituted by a social networking site.

14. The system of claim 12, the supporting application constituted by a social networking site.

15. The system of claim 1, the bank processor providing a plurality of options to the first customer includes the bank processor presenting the first customer with a GUI (graphical user interface) that includes at least one slider scale that controls a respective option.

16. The system of claim 15, the GUI including a first slider scale that controls the amount of the transaction, and a second slider scale that controls timing of the transaction.

17. The system of claim 15, the GUI including that adjustment of the first slider scale and adjustment of the second slider scale are interrelated.

18. A method for performing a funds transfer between a first customer and a second customer using a processing system, the processing system tangibly embodied in the form a computer, the processing system including a bank processor having a processor that performs processing in conjunction with the funds transfer; and a bank database which contains data used in the funds transfer; and the bank processor performing the method via the processor, the method including:
inputting, by the bank processor, a funds transfer request from the first customer through interfacing with the first customer, the bank processor providing a plurality of options to the first customer via an interactive interface that controls each option of the plurality of options,
generating, by the bank processor, first attributes of the funds transfer based on the options that are selected by the first customer initiating the funds transfer, wherein the options include at least one option in addition to selection of a receiver of funds and an amount of funds;
interfacing, by the bank processor, with the second customer, receiving the funds transfer from the first customer, including providing a plurality of options to the second customer, the plurality of options provided to the second customer comprising (i) an option to receive the funds for a fee on the same day that the second customer selects the options and (ii) an option to receive the funds for free on a subsequent day that the second customer selects the options;
generating, by the bank processor, second attributes of the funds transfer based on the options that are selected by the second customer, the options controlling second attributes of the funds transfer;
aggregating, by the bank processor, the first attributes and the second attributes to generate aggregated attributes; and
performing the funds transfer, by the bank processor, based on the aggregated first attributes and the second attributes; and
wherein the options provided to the first customer for controlling first attributes of the funds transfer include at least one selected from the set consisting of adjusting a timing of the funds transfer, adjusting a fee amount to be charged, and imposition of a hold on the funds transfer; and
wherein the options provided to the second customer for controlling second attributes of the funds transfer include at least one selected from the set consisting of adjusting a timing of the funds transfer, adjusting a fee amount to be charged, and selecting a physical location for delivery of funds.

19. The method of claim 18, the processing system being in the form of an add-on to a supporting application, the supporting application being a social networking application.

20. A processing system for performing a funds transfer between a first customer and a second customer, the processing system tangibly embodied in the form a computer, the processing system including:
one or more processors;
a bank database which contains data used in the funds transfer; and
memory having instructions stored thereon, the instructions, when executed by the one or more processors, cause the processors to perform operations comprising:
providing a plurality of options to the first customer;
inputting a funds transfer request from the first customer through interfacing with the first customer via an interactive interface that controls each option of the plurality of options;
generating first attributes of the funds transfer based on the options that are selected by the first customer initiating the funds transfer;
confirming that the funds transfer is viable based on the first attributes;
interfacing with the second customer, receiving the funds transfer from the first customer, including providing a plurality of options to the second customer, the plurality of options provided to the second customer comprising (i) an option to receive the funds for a fee on the same day that the second customer selects the options and (ii) an option to receive the funds for free on a subsequent day that the second customer selects the options;
generating second attributes of the funds transfer based on the options that are selected by the second customer, the options controlling second attributes of the funds transfer;
confirming that the funds transfer is viable based on the second attributes;
aggregating the first attributes and the second attributes to generate aggregated attributes; and
transferring the funds based on the aggregated attributes.

21. The processing system of claim 20, wherein the options controlling first attributes of the funds transfer includes placing funds into an escrow account, and release of the funds being conditional upon a trigger event.

22. The processing system of claim 21, wherein satisfying the trigger event is dependent on action by at least one of the first customer and the second customer.

23. The processing system of claim 20, wherein one of the first attributes of the funds transfer and second attributes of the funds transfer effects a least cost routing determination.

24. The system of claim 1, wherein the options provided to the first customer for controlling first attributes of the funds transfer include at least one from the set consisting of adjusting a timing of the funds transfer, adjusting a fee amount to be charged, and imposition of a hold on the funds transfer.

25. The system of claim 1, wherein the options provided to the second customer for controlling second attributes of the funds transfer include at least one from the set consisting of adjusting a timing of the funds transfer, adjusting a fee amount to be charged, and selecting a physical location for delivery of funds.

26. The system of claim 1, the interfacing with the first customer including the bank processor presents the first customer with a plurality of option sets, each option set generated based on attributes entered by the first customer, and each option set containing a plurality of attributes that the first customer may choose as a set; and
the bank processor presents the first customer with a plurality of option sets; and
the bank processor provides the first customer the option to change the attributes in at least one option set;
the bank processor provides the second customer with a plurality of option sets; and
the bank processor provides the second customer the option to change the attributes in at least one option set;
the interfacing with the first customer constituted by the bank processor interfacing with a user device of the first customer, and the interfacing with the second customer constituted by the bank processor interfacing with a user device of the second customer; and
the bank processor respectively inputting further attributes from the first user device and the second user device, the further attributes user by the bank processor to perform the funds transfer.
